(19) United States
(12) Patent Application Publication
(10) Pub. No.: US 2020/0306775 A1
(43) Pub. Date: Oct. 1, 2020

(54) FOAM DISPENSING UNIT

(71) Applicant: Kerry McKinley, Newtown, CT (US)

(72) Inventor: Kerry McKinley, Newtown, CT (US)

(21) Appl. No.: 16/827,897

(22) Filed: Mar. 24, 2020

Related U.S. Application Data
(60) Provisional application No. 62/823,170, filed on Mar. 25, 2019.

(51) Int. Cl. B05B 7/00; B05B 12/14; B05B 7/16

(52) U.S. Cl. CPC B05B 7/0031; B05B 7/16; B05B 12/14

(57) ABSTRACT

The present foam dispensing unit comprises a manifold defining a first channel and a second channel. The first channel defines an input for receiving a first liquid and an output for directing the first liquid into a mixing nozzle. The second channel defines an input for receiving a second liquid, and an output for directing the second liquid into the mixing nozzle. The foam dispensing unit further comprises a first flow adjustment mechanism positioned along the first channel for controlling a flow of the first liquid at the output of the first channel, and a second flow adjustment mechanism positioned along the second channel for controlling a flow of the second liquid at the output of the second channel.

### TECHNICAL FIELD

The present disclosure relates to the field of foam dispensers, and more particularly to an improved foam dispensing unit.

### BACKGROUND

Foam dispensing units are well known in the art. Examples of foam dispensing units are described in U.S. Pat. No. 8,783,517 issued on Jul. 22, 2014 and assigned to P G United States Israel Ltd. Foam dispensing units produce foam in a mixing chamber by combining intersecting jets of two liquids. The two liquids are injected in the mixing chamber using pumps, and the resulting foam is ejected through a nozzle.

Many efforts have been made to reduce clogging in the nozzle of the foam dispensing units, as for example described in U.S. Pat. No. 8,789,725 issued on Jul. 29, 2014 and assigned to P G United States Israel Ltd, and U.S. Pat. No. 8,978,719, issued on Mar. 17, 2015 also assigned to P G United States Israel Ltd. Prior art solutions typically relied on mechanisms for closing the mixing chamber of a mixing nozzle when stopping use of the foam dispensing unit and providing a mechanism to systematically remove foam in the mixing nozzle upon removing therefrom of a fitting used to fill the bag when the foam is expelled by the mixing nozzle. Although those solutions have consequentially reduced waste in the foam dispensing industry, there still remains room for further improvements.

There is therefore a need for an improved foam dispensing unit for improving the consistency of foam produced, which would further improve the quality of the foam generated, and thereby prevent clogging in the foam dispensing unit.

### SUMMARY

According to a first aspect, the present disclosure relates to a foam dispensing unit comprising a mixing nozzle having a mixing chamber for combining first and second liquids received therein and ejecting therefrom a foam. The foam dispending unit further comprises a manifold defining a first channel and a second channel, the first channel having an input for receiving the first liquid and an output for directing the first liquid into the mixing nozzle, the second channel having an input for receiving the second liquid and an output for directing the second liquid into the mixing nozzle, the foam dispensing unit further comprising a first flow adjustment mechanism positioned along the first channel for controlling a flow of the first liquid at the output of the first channel, the foam dispensing unit further comprising a second flow adjustment mechanism positioned along the second channel for controlling a flow of the second liquid at the output of the second channel. The foam dispensing unit further comprising a heating element for heating the first and second channels of the manifold.

According to an aspect, the first flow adjustment mechanism controls the flow of the first liquid in the first channel by modifying size of a section of the first channel, and the second flow adjustment mechanism controls the flow of the second liquid in the second channel by modifying size of a section size of the second channel.

According to an aspect, the foam dispensing unit further comprises a manual shutoff for closing the first channel and the second channel individually or simultaneously.

According to another aspect, the foam dispensing unit further comprises at least one pressure sensor for measuring one of the following: a pressure of the first liquid or a pressure of the second liquid.

According yet to another aspect, the foam dispensing unit further comprises a plurality of pressure sensors, one of the pressure sensors measuring a pressure of the first liquid in the first channel and one of the pressure sensors measuring a pressure of the second liquid in the second channel.

According to another aspect, the foam dispensing unit further comprises a locking mechanism for stopping ejection of the first and second liquids from the first and second channels of the manifold into the mixing nozzle for allowing disconnection of the mixing nozzle.

According to yet another aspect, the foam dispensing unit further comprises a flow sensor, the flow sensor metering one of the following: a flow of the first liquid or a flow of the second liquid.

According to another aspect, the foam dispensing unit further comprises a plurality of flow sensors, one of the flow sensors metering a flow of the first liquid, and one of the flow sensors metering a flow of the second liquid.

According to yet another aspect, the plurality of flow sensors transmits the flow of the first liquid and the flow of the second liquid wirelessly.

According to another aspect, the plurality of flow sensors are electronically connected to a processor executing instructions which upon receipt of measures of the flow of the first liquid and the flow of the second liquid by the flow sensors, calculates the required adjustment of the first flow adjustment mechanism and the second flow adjustment mechanism and sends instructions to the first flow adjustment mechanism and the second flow adjustment mechanism accordingly.

### BRIEF DESCRIPTION OF THE DRAWINGS

Embodiments of the disclosure will be described by way of example only with reference to the accompanying drawings, in which:

FIG. 1 is a right-side perspective view of the present foam dispensing unit, illustrating the present manifold with two sensors (pressure and/or flow), a mixing nozzle and a manual shutoff;

FIG. 2 is a front perspective view of the foam dispensing unit of FIG. 1;

FIG. 3 is a bottom front perspective of the foam dispensing unit of FIG. 1;

FIG. 4 is a right-side elevation view of the foam dispensing unit of FIG. 1;

FIG. 5 is a top elevation view of the foam dispensing unit of FIG. 1; and

FIG. 6 is a left-side elevation view of the foam dispensing unit of FIG. 1.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Aspects of the present disclosure address the present manifold, and the present foam dispensing unit equipped with the present manifold. The present manifold and foam dispensing unit may be used with any type of foam injection apparatus or device which is known to produce foam by mixing two liquids in a mixing chamber of a mixing nozzle.

For simplicity's sake, the present description will not depict nor describe the well-known components and aspects of foam injection apparatuses or devices. The present description and Figures focus on an improved manifold and on a foam dispensing unit equipped with the improved manifold. For sake of clarity, the term “manifold” is used here through to refer to a component of foam injection apparatus that connects a mixing nozzle to connectors through which are received two liquids which when mixed together in the mixing nozzle, as described for example in U.S. Pat. No. 8,783,517, chemically react together to generate foam that is ejected by the mixing nozzle. Thus, the present description and figures are directed at addressing the problems with the flow of the two liquids in the mixing nozzle, by providing a manifold for improving the quality of the foam generated in the mixing chamber of the mixing nozzle upon combination of the two liquids in the mixing nozzle, and to reducing crystallizing problems within the manifold and the mixing nozzle, as well as the foam dispensing unit equipped therewith.

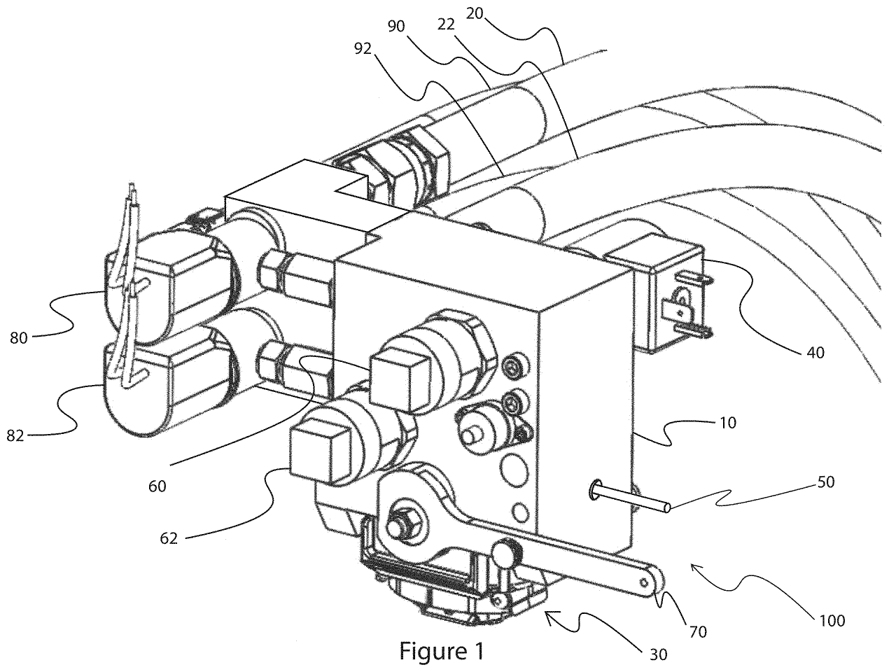

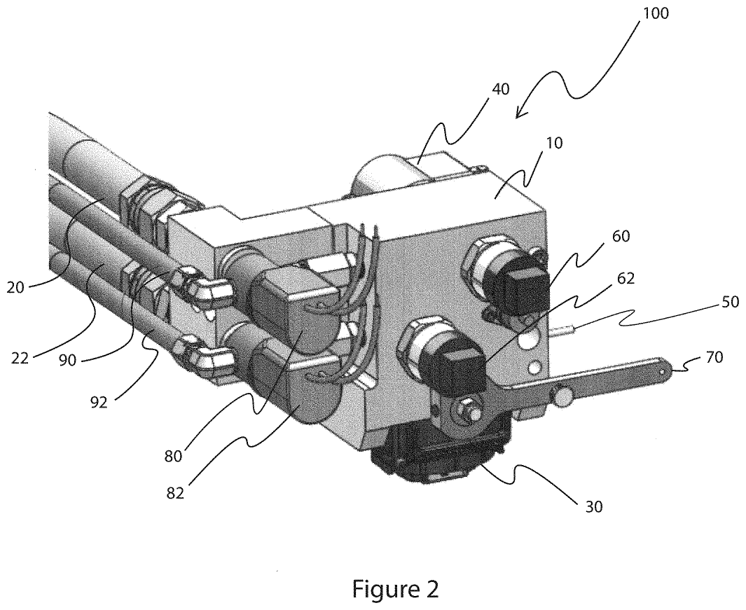

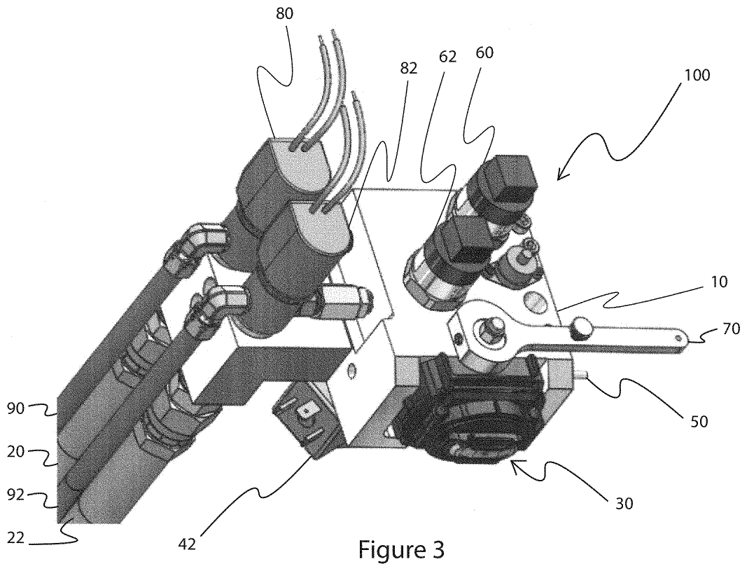

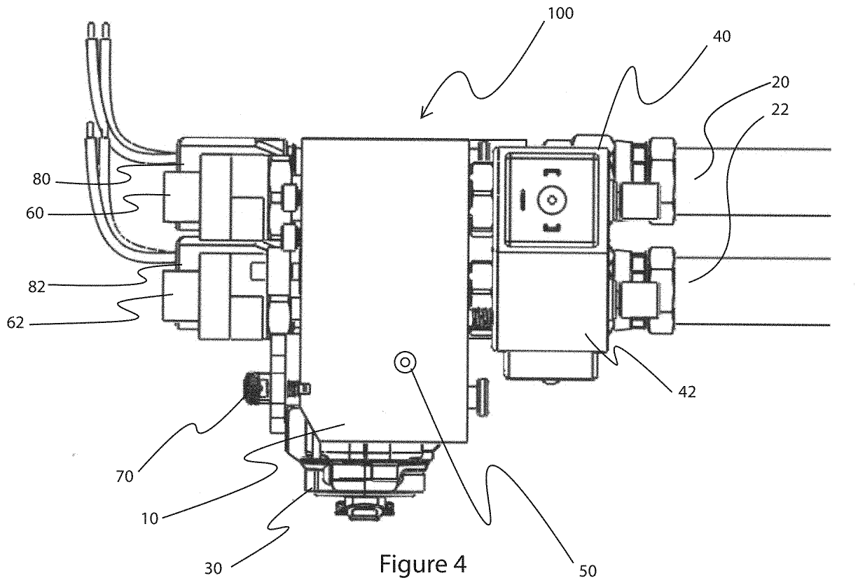

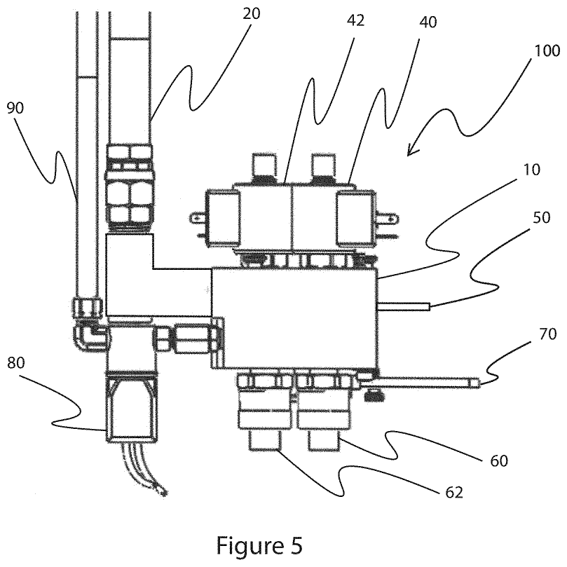

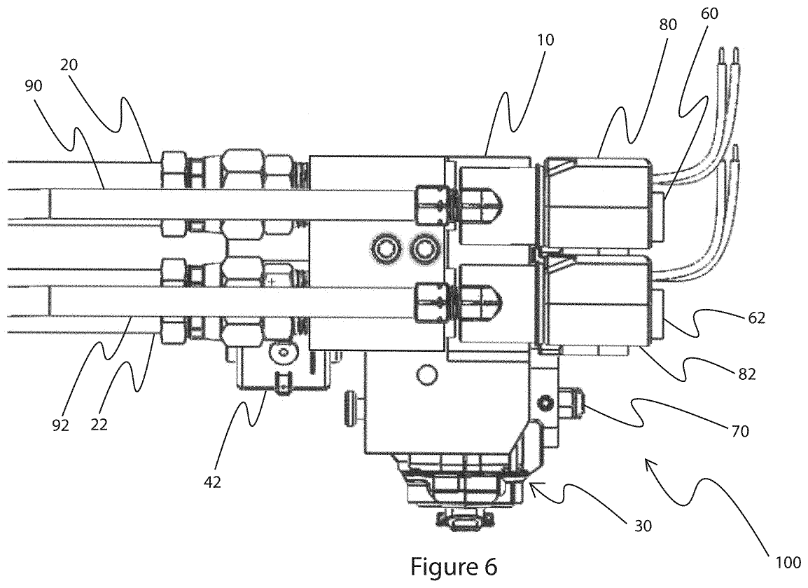

Referring now concurrently to FIGS. 1 to 6, there is respectively shown various views of the present foam dispensing unit 100 equipped with the present manifold 10. The manifold 10 comprises a body which defines a first and a second channels. The first and second channels of the body each respectively comprises an input and an output. The input of the first channel of the manifold 10 is adapted to be connected to the first pipe 20 to receive the first liquid. The input of the second channel of the manifold 10 is adapted to be connected to the second pipe 22 to receive the second liquid. The first channel of the manifold directs and controls the flow of the first liquid received towards the output of the first channel. The second channel of the manifold directs and controls the flow of the second liquid received towards the output of the second channel. The output of the first channel and the output of the second channel respectively output the first liquid and the second liquid into a nozzle 30. Reference to U.S. Pat. No. 8,783,517 is made for a description of the operation of the nozzle 30 with a mixing chamber for receiving the first liquid and the second liquid, mixing therein the first and the second liquids and ejecting resulting foam.

Throughout the present specification, the word pipe is used to refer to any cylindrical medium which is adapted for carrying the first and second liquids to the manifold 10. For sake of simplicity, the following description will refer to pipes 20 and 22, but a person skilled in the art will understand that such pipes need to be connected to the manifold through connectors such as screwed connectors, clamp connectors or any other type of connector which permits connection of the pipes 20 and 22 with the inputs of the first and the second channels of the manifold 10.

The first liquid and the second liquid are pumped into the manifold 10 by two separate pumps (not shown). Depending on environmental conditions, the first liquid and the second liquid may not have the same consistency, and adjustment of the flow of the first liquid and the second liquid may be required. Another problem that often arises is caused by the wearing of the pumps, which although perfectly balanced upon installation, are not properly balanced after some time. Yet another problem may arise from the inconsistency of the first and the second liquids between different batches, which results in the mixing nozzle 30 not receiving a balanced ratio of the first and the second liquids.

To overcome the above-mentioned problems, the present manifold 10 and the present foam dispensing unit 100 are provided with a pair of flow adjustment mechanisms 40 and 42. A first flow adjustment mechanism 40 is positioned along the first channel of the manifold 10, for example at the input of the first channel, and controls a flow of the first liquid into the first channel of the manifold 10. A second flow adjustment mechanism 42 is positioned along the second channel of the manifold 10, for example at the input of the second channel, and controls a flow of the second liquid in the second channel of the manifold 10. The first and the second flow adjustment mechanisms 40 and 42 may be manually adjusted by an operator of the foam dispending unit 100. Alternatively, the first and the second flow adjustment mechanisms 40 and 42 are operated by two motors (not shown). By adjusting the flow of the first liquid and of the second liquid entering into the mixing nozzle 30, it is possible to ensure a more precise ratio of the first and the second liquids, without having to adjust or replace the pumps providing the first and the second liquids to the foam dispensing unit 100.

The manifold 10 is further provided with a heating element 50. The heating element 50 heats the first channel and the second channel of the manifold 10, to improve consistency of the first and the second liquids flowing respectively through the first channel and the second channel of the manifold 10.

More particularly, the first flow adjustment mechanism 40 controls the flow of the first liquid in the first channel by modifying size of a section of the first channel. For example, the first flow adjustment may consist in a cylindrical member which pushes against the first channel so as to reduce, in the vicinity of the extremity of the cylindrical member, a cross-section of the first channel thereby reducing the flow of the first liquid in the first channel of the manifold 10. Similarly, the second flow adjustment mechanism 42 may consist in a cylindrical member which pushes against the second channel so as to reduce, in the vicinity of the extremity of the second cylindrical member, a cross-section of the second channel thereby reducing the flow of the second liquid in the second channel of the manifold 10. The present manifold 10 and the present foam dispensing unit 100 are not limited to such an example of first and second flow adjustment mechanisms 40 and 42, and any type of adjustment which may reduce the flow of liquid in a channel may be used. The first and second flow adjustment mechanisms 40 and 42 may be inserted within the body of the manifold 10, may be affixed to the manifold 10 or may be embedded within the body of the manifold 10 upon manufacturing of the manifold 10.

The manifold 10 may be made of any material known in the industry, non-chemically reactive with the first and the second liquids, tensile to allow adjustment of the first and second channels, and preferably with heat conductivity quality to allow heating the first and the second channels by a heating element (discussed further).

The manifold 10 is further adapted for receiving at least one sensor 60. The at least one sensor 60 may inserted inside the body of the manifold 10, embedded in the body of the manifold 10 or affixed to the manifold 10. The at least one sensor 60 may be a pressure sensor or a flow sensor. The figures depict two sensors 60 and 62, but the present manifold 10 and foam dispensing unit 100 are not limited to such an implementation, and one or multiple sensors could be used without departing from the scope of the present invention. However, for simplicity purposes, the remainder of the present description will refer to the pair of sensors 60 and 62. The sensors 60 and 62 are adapted for measuring a pressure in one of the first and second channels of the manifold 10 or metering a flow of the liquid in the first and second channels. In a particular aspect, two pressure sensors are used: one pressure sensor for measuring the pressure of the first liquid in the first channel and another pressure sensor for measuring the pressure of the second liquid in the second channel of the manifold 10. In other aspect, two flow sensors are used: one flow sensor for metering the flow of the first liquid in the first channel and another flow sensor for metering the flow of the second liquid in the second channel. In yet another aspect, two pressure sensors and two flow sensors are used: one pressure sensor for measuring the pressure of the first liquid in the first channel with one flow sensor for metering the flow of the first liquid in the first channel, and another pressure sensor for measuring the pressure of the second liquid in the second channel with another flow sensor for metering the flow of the second liquid in the second channel.

The sensors 60 and 62 may electrically or wirelessly transmit the measured pressure and metered flow to a processor (not shown). The processor may be affixed to the body of the manifold 10, or remotely located. In a particular variant, the processor may be part of an electronic device, such as for example a computer, a server, a tablet, a phone, in direct or indirect wireless communication with the sensors 60 and 62. The processor executes instructions which, upon receipt of the metered or measured flow of the first liquid and the flow of the second liquid or the metered or measured pressure of the first liquid and the second liquid, calculates the required adjustment to the first flow adjustment mechanism 40 and the second flow adjustment mechanism 42 and sends instructions to the first flow adjustment mechanism 40 and the second flow adjustment mechanism 42 accordingly. Alternatively or concurrently, the processor further executes instructions which, upon receipt of the measured pressure of the first liquid in the first channel and the second liquid in the second channel, calculates the required adjustment to the first flow adjustment mechanism 40 and the second flow adjustment mechanism 42 and sends instructions the first and second flow adjustments accordingly.

The processor further executes instructions which, upon receipt of the metered or measured flow of the first liquid and the flow of the second liquid, determines that the heating element 50 should be adjusted, and send instructions to the heating element 50 accordingly. Thus the processor adjusts one or several of the first flow adjustment mechanism 40, the second flow adjustment mechanism 42 and the heating element 50 to ensure that the ratio of the first and the second liquids entering the mixing nozzle 30 is as optimal as possible based on the conditions.

Adjusting the flow and/or pressure of the first liquid in the first channel and the flow and/or pressure of the second liquid in the second channel and/or adjusting the heating element 50 ensures maintaining a correct ratio of first and second liquids entering the mixing nozzle 30, resulting in generation of quality foam, even when the consistency of the first and second liquids varies, the environment conditions affect the consistency of the first and second liquids, or the pumps for the first and second liquids are wearing unevenly.

Furthermore, depending on the pressure measured in the first and second channels and the flow metered in the first and second channels, the processor is capable of determining that the temperature in the vicinity of the manifold 10, and accordingly the foam dispensing unit 100, is below the recommended temperature range, and may activate the heating element 50 so as to prevent crystallizing in the first and second channels of the manifold 10.

The foam dispensing unit 100 may further comprise a manual shutoff 70 for closing the output of the first channel and the output of the second channel simultaneously. The manual shutoff 70 may for example consists of a cam, which upon rotation closes the outputs of the first and the second channels of the manifold 10.

The foam dispensing unit 100 is further provided with a pair of pressure relief valves 80 and 82 and a pair of pressure relief pipes 90 and 92. Depending on the pressure or other factor(s), it is possible that an undesired residual pressure resides between the mixing nozzle 30 and the first and the second flow adjustment mechanisms 40 and 42, and/or or between the mixing nozzle 30 and the first and second channels of the manifold 10. The presence of such residual pressure may be detected by the sensors 60 and 62 and reported to the processor. To release such residual pressure, the pressure relief valves 80 and 82 may be manually actuated by an operator of the foam dispensing unit 100. Alternatively, the pressure relief valves 80 and 82 may be electronically actuated by the processor or any other known electronic device in electric or wireless communication with the pressure relief valves 80 and 82. The pressure relief valves 80 and 82 allow release of the residual pressure in the first and the second channels respectively of the manifold 10 into the pressure relief pipes 90 and 92 separately or simultaneously. The pressure relief valves 80 and 82 and the pressure relief pipes 90 and 92 prevent any unwanted flow of the first and the second liquids in the first and the second channels respectively into the mixing nozzle 30, and prevent unwanted mixing of liquids, dripping of liquids or mixed liquids as well as unnecessary buildup of reacted liquids thereby allowing for a longer usage of the mixing nozzle 30.

The pressure relief can be achieved using different methods such as the pressure relief valves 80 and 82 and the pressure relief pipes 90 and 92 for returning the undesired liquid into their respective liquid supply containers (not shown). The pressure relief can alternately be performed by other methods such as for example using bellows or expanding chambers to relieve pressure of the undesired pressure in the first and the second channels of the manifold 10 without departing from the scope of the present invention.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A foam dispensing unit comprising:
a mixing nozzle having a mixing chamber for combining first and second liquids received therein and ejecting therefrom a foam;
a manifold defining a first channel and a second channel, the first channel having an input for receiving the first liquid and an output for directing the first liquid into the mixing nozzle, the second channel having an input for receiving the second liquid and an output for directing the second liquid into the mixing nozzle;
a first flow adjustment mechanism positioned along the first channel for controlling a flow of the first liquid at the output of the first channel;
a second flow adjustment mechanism positioned along the second channel for controlling a flow of the second liquid at the output of the second channel; and
a heating element for heating the first and second channels of the manifold.

2. The foam dispensing unit of claim 1, wherein:
the first flow adjustment mechanism controls the flow of the first liquid in the first channel by modifying size of a section of the first channel; and
the second flow adjustment mechanism controls the flow of the second liquid in the second channel by modifying size of a section size of the second channel.

3. The foam dispensing unit of claim 1, further comprising a manual shutoff for closing the output of the first channel and the output of the second channel simultaneously.

4. The foam dispensing unit of claim 1, further comprising a pressure sensor, the pressure sensor measuring one of the following: a pressure of the first liquid, or a pressure of the second liquid.

5. The foam dispensing unit of claim 1, further comprising a plurality of pressure sensors, one of the pressure sensors measuring a pressure of the first liquid in the first channel, and one of the pressure sensors measuring a pressure of the second liquid in the second channel.

6. The foam dispensing unit of claim 1, further comprising a flow sensor, the flow sensor metering one of the following: a flow of the first liquid, or a flow of the second liquid.

7. The foam dispensing unit of claim 1, further comprising a plurality of flow sensors, one of the flow sensors metering a flow of the first liquid and one of the flow sensors metering a flow of the second liquid.

8. The foam dispensing unit of claim 7 wherein the plurality of flow sensors transmits the measured flow of the first liquid and the flow of the second liquid wirelessly.

9. The foam dispensing unit of claim 7, wherein the plurality of flow sensors are electronically connected to a processor, the processor executing instructions which upon receipt of the measured flow of the first liquid and the measured flow of the second liquid, calculates the required adjustment to the first flow adjustment mechanism and the second flow adjustment mechanism and sends instructions the first flow adjustment mechanism and the second flow adjustment mechanism accordingly.

10. The foam dispensing unit of claim 1, further comprising two pressure relief valves and two pressure relief pipes, one of the pressure relief valve and pressure relief pipe being connected to the first channel and are adapted for releasing undesirable pressure of the first liquid in the first channel, another one of the pressure relief valve and another one of the pressure relief pipe being connected to the second channel and are adapted for releasing undesirable pressure of the second liquid in the second channel.
